(19) United States
(12) Patent Application Publication
(10) Pub. No.: US 2020/0364308 A1
(43) Pub. Date: Nov. 19, 2020

(54) STORAGE TRACE ANALYTICS

(71) Applicant: EMC Corporation, Hopkinton, MA (US)

(72) Inventors: Assaf Natanzon, Tel Aviv (IL); Nir Goldschmidt, Herzelia (IL); Anat Parush Tzur, Be'er Sheva (IL)

(21) Appl. No.: 14/674,274

(22) Filed: Mar. 31, 2015

(51) Int. Cl. G06F 17/30

(52) U.S. Cl. CPC G06F 17/30312; G06F 17/30289

(57) ABSTRACT

A method, a computer program product, and a system for analyzing heterogeneous storage system data, the method comprising receiving metadata from storage systems; analyzing the metadata; and based on the analyzed metadata, providing recommendations to the storage systems.

A portion of the disclosure of this patent document may contain command formats and other computer language listings, all of which are subject to copyright protection. The copyright owner has no objection to the facsimile reproduction by anyone of the patent document or the patent disclosure, as it appears in the United States Patent and Trademark Office patent file or records, but otherwise reserves all copyright rights whatsoever.

### TECHNICAL FIELD

This disclosure relates generally to big data storage analytics.

### BACKGROUND

Businesses and other enterprises generate large amounts of information, which may be stored in a cost-effective manner while ensuring acceptable levels of availability, security, and accessibility. Currently, stored information is managed through a set of manual, automatic, or semi-automatic policies, procedures, and practices. These methods are applied in a variety of ways to a variety of data and data storage systems.

### SUMMARY

A method, a computer program product, and a system for analyzing heterogeneous storage system data, the method comprising receiving metadata from storage systems; analyzing the metadata; and based on the analyzed metadata, providing recommendations to the storage systems.

### BRIEF DESCRIPTION OF THE DRAWINGS

Objects, features, and advantages of embodiments disclosed herein may be better understood by referring to the following description in conjunction with the accompanying drawings. The drawings are not meant to limit the scope of the claims included herewith. For clarity, not every element may be labeled in every figure. The drawings are not necessarily to scale, emphasis instead being placed upon illustrating embodiments, principles, and concepts. Thus, features and advantages of the present disclosure will become more apparent from the following detailed description of exemplary embodiments thereof taken in conjunction with the accompanying drawings in which:

FIG. 1 is a simplified illustration of a block diagram of a system for collecting a high volume of information from storage systems in accordance with an embodiment of present disclosure;

FIG. 2 is a simplified illustration of a block diagram of an analytics platform collecting a high volume of information from agent software that runs in each storage system in accordance with an embodiment of present disclosure;

FIG. 3 is a simplified illustration of a block diagram of an analytics platform accessing storage systems using an application program interface (API) in accordance with an embodiment of present disclosure;

FIG. 4 is a simplified block diagram illustrating a method of an analytics platform receiving a high volume of information in accordance with an embodiment of present disclosure;

FIG. 5 is a simplified block diagram illustrating a method of deploying and running a software agent in accordance with an embodiment of present disclosure;

FIG. 6 is a simplified block diagram illustrating a method of an analytics platform sending storage system metadata and an API receiving storage system metadata in accordance with an embodiment of present disclosure;

FIG. 7 is a simplified block diagram illustrating a method of an analytics platform analyzing storage metadata and sending recommendations to storage systems in accordance with an embodiment of present disclosure;

FIG. 8 is a simplified block diagram illustrating a method of a storage system receiving and acting upon a recommendation in accordance with an embodiment of present disclosure;

FIG. 9 is a diagram illustrating an example embodiment method of the present disclosure embodied as a computer program product; and

FIG. 10 is an example of an embodiment of an apparatus that may utilize the techniques described herein, in accordance with an embodiment of the present disclosure.

### DETAILED DESCRIPTION

Traditionally, workload data is captured from a data storage system for different reasons. Typically, one reason workload data is captured from a data storage system is for troubleshooting analysis. Generally, workload data is also captured from a data storage system for performance-related issues. Typically, a problem encountered in trace processing and analysis is that a huge amount of information may be contained in a captured trace. Typically, a trace size for several minutes of data collection may reach hundreds of megabytes. Generally, because of size constraints, an analysis program may not be able to hold all relevant data in computer memory.

Traditionally, the size of a trace file depends on the events being traced, the number of Inputs/Outputs (IOs) traced, and the trace duration. Generally, accessed data in the form of a trace file may be made ready for analysis. Usually, a trace file may contain information about IO activity also referred to workload data on data storage systems from which the trace file was accessed.

In many embodiments, exemplary data storage systems for which workload data may be captured and analyzed may be Symmetrix® Integrated Cache Disk Arrays, Celerra® Data Access Real Time (DART) file system, and ViPR® software-defined storage system, all available from EMC Corporation of Hopkinton, Mass. In other embodiments, the techniques of the current disclosure may be applied to data storage systems in general.

In many embodiments, there may be an analytics platform that may receive information of input/output (IO) activity produced in different data storage systems. In some embodiments, the information received by an analytics platform may relate to load characteristics of the different storage systems. In certain embodiments, there may be a software framework that stores, processes, and analyzes big data. In other embodiments, there may be an analytics platform that may process and analyze information received from different storage systems and stored on a software framework. In many embodiments, there may be an analytics platform that may analyze trace data. In certain embodiments, there may be an analytics platform that may provide recommendations to different data storage systems to change its configuration based on a load prediction ascertained from analyzed information received from different storage systems. In some embodiments, there may be an analytics platform that may provide recommendations to an end user of a storage system to change the configuration of its storage system based on a load prediction ascertained from analyzed information received from different storage systems. In other embodiments, an analytics platform may provide recommendations to a storage system to move data from one storage array to another storage array. In certain embodiments, an analytics platform may provide recommendations to a storage system recommending a more efficient storage system based on the current storage system's usage of data. In many embodiments, an analytics platform may provide recommendations to a storage system recommending a more efficient storage system based on a prediction of the storage system's future load characteristics.

In many embodiments, an analytics platform may have the following components: a software agent, a software framework, and an analytics platform. In some embodiments, a software agent may activate automatically. In certain embodiments, a software agent may be in a wait status on a storage system. In many embodiments, a software agent in a wait status may be awaiting recommendations from an analytics platform. In other embodiments, a software agent may be in a run status on a storage system. In certain embodiments, a software agent in a run status may be executing recommendations received from an analytics platform. In many embodiments, big data may be referred to as a high volume of information. In many embodiments, a software agent may receive a high volume of information from an analytics platform. In some embodiments, a software agent may send metadata from storage systems to an analytics platform. In certain embodiments, a software agent may receive storage system recommendations from an analytics platform to change storage system configurations. In many embodiments, a change in a storage system configuration may include moving data within a storage system to increase performance of the storage system.

In many embodiments, a software agent may collect information relating to load characteristics of a storage system. In some embodiments, a software agent may collect information pertaining to which port an IO was received. In certain embodiments, a software agent may collect information pertaining to which logical unit received an IO, the offset of the IO and the Length of the IO. In other embodiments, a software agent may collect information pertaining to the time the IO began and ended. In many embodiments, a software agent may collect information pertaining to the current placement of data in a storage system.

In many embodiments, a software agent may collect information in a file system pertaining to which file received an IO. In some embodiments, a software agent may collect information in a file system pertaining to which file opened for IO.

In certain embodiments, a software agent may collect information varying from storage system to storage system. In some embodiments, a software agent may send information chronologically to an analytics platform. In many embodiments, a software agent may periodically send information to an analytics platform.

In many embodiments, a software agent may send information through various protocols. In some embodiments, a software agent may send information to an analytics platform using Fibre Channel (FC) protocol.

In many embodiments, a software framework may be Hadoop®. In other embodiments, a software framework may store and process big data. In some embodiments, a software framework may distribute data and associated computing (e.g., execution of application tasks). In certain embodiments, a software framework may provide the ability to reliably store huge amounts of data.

In many embodiments, an analytics platform may receive information from different storage systems. In some embodiments, an analytics platform may preprocess data received from different storage systems. In certain embodiments, an analytics platform may store information, or data, to a software framework. In many embodiments, an analytics platform may be built on different big data platforms to run big data analysis.

In many embodiments, an analytics platform may allow the running of pluggable applications [e.g., storage planner, fully automated storage tiering (FAST)] using data in a software framework utilizing an application program interface (API). In certain embodiments, an analytics platform may enable running of pluggable applications using data in cached information utilizing an API. In some embodiments, an API may be MapReduce (MR) jobs that may run on top of a software framework. In other embodiments, an API may be Python/CPP libraries that may enable access to information in a software framework cluster. In some embodiments, an API may be Python/CPP libraries that may enable access to information in a platform cache (in near real-time data). In some embodiments, an analytics platform may provide storage systems with information resulting from using data in a software platform and cached information utilizing an API.

In certain embodiments, an analytics platform may develop a prediction algorithm relating to load characteristics of different storage systems. In many embodiments, having access to a storage system's history may allow running of prediction algorithms. In other embodiments, an analytics platform may develop one or more predictive algorithms that determine where data should be placed or where data will be placed. In some embodiments, an analytics platform may periodically analyze data received from storage systems. In many embodiments, an analytics platform may make decisions based on data received from storage systems. In other embodiments, an analytics platform may send metadata about a decision made by an analytics platform to a storage system. In other embodiments, an analytics platform may send data about a decision made by an analytics platform to a storage system.

In many embodiments, an analytics platform may utilize a FAST algorithm. In certain embodiments, an analytics platform may make a recommendation as to where to move data within a storage system to increase performance of the storage system based on the FAST algorithm.

In many embodiments, an analytics platform may enable auto-tiering of information between different storage systems. In certain embodiments, an analytics platform may enable control of auto-tiering between different storage systems. In other embodiments, auto-tiering of storage systems may be based on an examination of metadata of IOs' activities over long periods of time. In certain embodiments, auto-tiering may move stored data based on predicted future behavior of an IO by tracking IO pattern in storage systems. In some embodiments, an analytics platform may control the auto-tiering of data between different storage systems. In certain embodiments, auto-tiering may utilize an advanced or complex big data analysis methodology. In other embodiments, auto-tiering may utilize machine learning techniques. In other embodiments, auto-tiering control may provide efficient data placement across different storage arrays. In many embodiments, analytics platform may impact auto-tiering of different storage systems through hinting. In some embodiments, hinting may impact auto-teiring by sending hints to a storage system on what storage system data should be placed and on what tier data should be placed on within a given storage system. In certain embodiments, an analytics platform may create smart hinting. In many embodiments, smart hinting may diagnose a storage system problem and provide recommendations on how storage system configurations may be changed to improve storage system performance. In other embodiments, an analytics platform may enable cache hinting to improve cache performance. In certain embodiments, improved cache performance may include plugging a flash card into a specific host in the system to enable more IOs to be stored on the read cache of the host system.

In many embodiments, an analytics platform may create algorithms that may be used for auto-tiering based on an IO pattern analysis in different storage systems. In some embodiments, an analytics platform may create algorithms that may be used to control tiering in different storage systems. In certain embodiments, an analytics platform may create algorithms to create hints for storage system tiering. In other embodiments, algorithms may be created for predicting periodic IO activity behavior that may enable auto-tiering. In many embodiments, an analytics platform may create algorithms that may predict hot spots in a cache which may enable better cache hits. In many embodiments, an analytics platform may create algorithms for defragmentation of file systems based on expected IO pattern while not performing defragmentation on locations that may not be expected to be accessed.

In many embodiments, an analytics platform may enable large-scale impact prediction. In some embodiments, large-scale impact prediction may enable access to storage system information to be logged. In other embodiments, large-scale impact prediction may enable location of IO within a storage system with exactness. In certain embodiments, large-scale impact prediction may enable logged access information to predict the impact of adding more cache to a storage system. In many embodiments, addition of more cache to a storage system may increase the performance of a SATA solid-state drive (SSD) cache on storage systems.

In other embodiments, an analytics platform may utilize a product advisor. In other embodiments, a product advisor may analyze storage system information. In some embodiments, a product advisor may perform a storage system examination. In certain embodiments, a product advisor may collect information during storage system examination to be used to advise storage system about expected data growth that may result in processing delays. In many embodiments, a product advisor may suggest an alternative storage system equipped to handle an increase in data growth experienced by a storage system. In certain embodiments, a product advisor may utilize a product simulator to be used to simulate data flow on alternative storage systems and examine the efficiency of alternative storage systems.

In certain embodiments, an analytics platform may enable federation of storage systems. In some embodiments, federation of storage systems may enable an analysis of data obtained from various storage systems by a single analytics platform. In many embodiments, federation of storage systems may determine which logical unit may be moved between two storage arrays due to increased usage to improve performance of the logical unit.

In many embodiments, an analytics platform may enable IO replay. In some embodiments, IO replay may enable storage system usage information pertaining to LUNs to be replayed. In certain embodiments, an analytics platform may collect traces continuously to record IO patterns within a storage system. In other embodiments, collection of traces may enable replay of IO patterns that occurred before a storage system crashed.

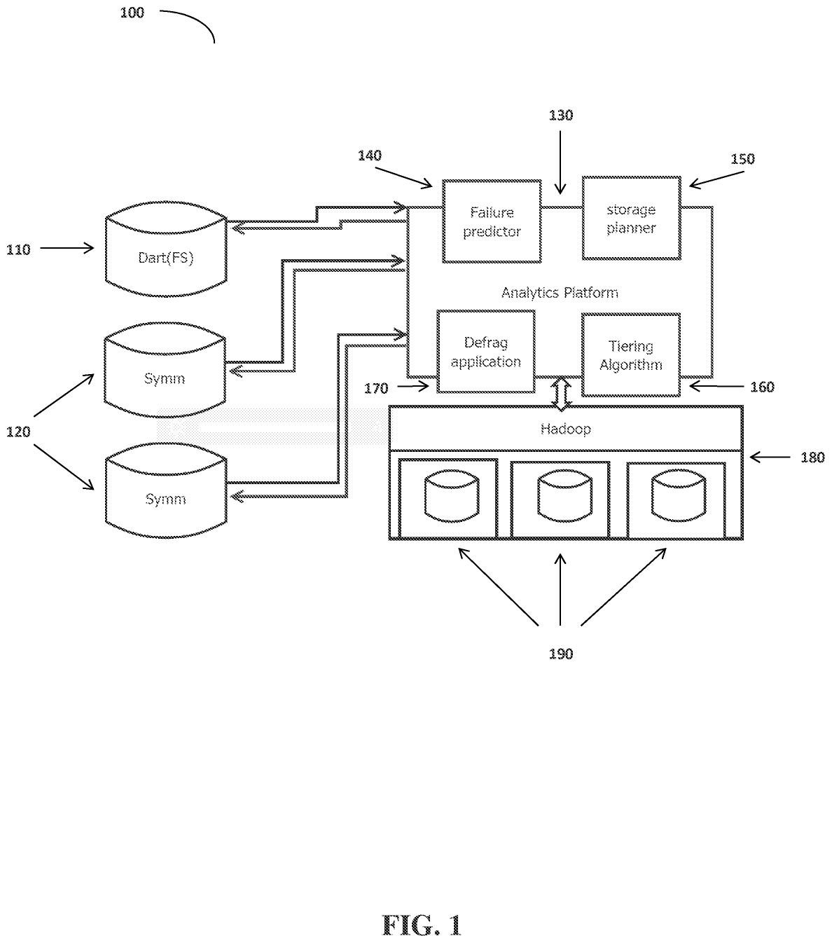

Refer now to the example embodiment of FIG. 1, which is a simplified illustration of a block diagram of a system for collecting a high volume of information from storage systems. In FIG. 1, system 100 includes storage system 110 and storage systems 120. Storage system 110 is a file system. Storage systems 120 are data storage systems. System 100 also includes analytics platform 130 that is in communication with storage system 110 and storage systems 120. Analytics platform 130 includes failure predictor 140, storage planner 150, tiering algorithm 160, and defragmentation (defrag) application 170. System 100 also includes software framework 180 that is in communication with analytics platform 130. Software framework 180 includes storage units 190.

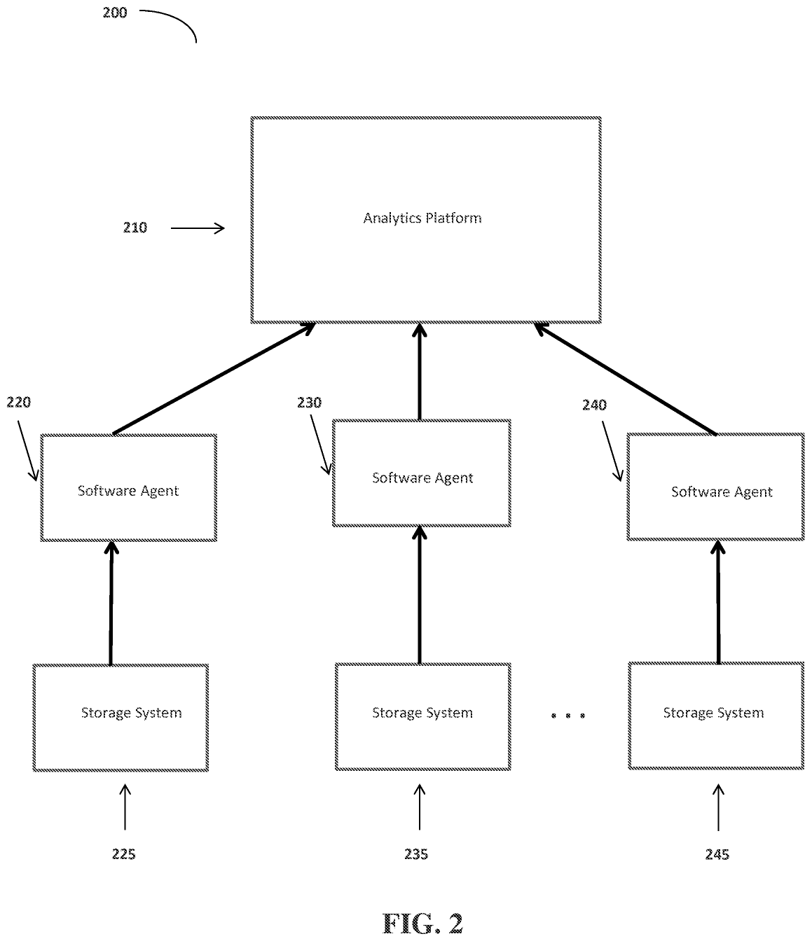

Refer now to the example embodiment of FIG. 2, which illustrates a simplified illustration of a block diagram of an analytics platform receiving a large volume of information from software agents that run within each storage system. System 200 includes analytics platform 210. Analytics platform 210 is in communication with software agent 220 that runs within storage system 225. Analytics platform 210 is in communication with software agent 230 that runs within storage system 235. Analytics platform 210 is in communication with software agent 240 that runs within storage system 245.

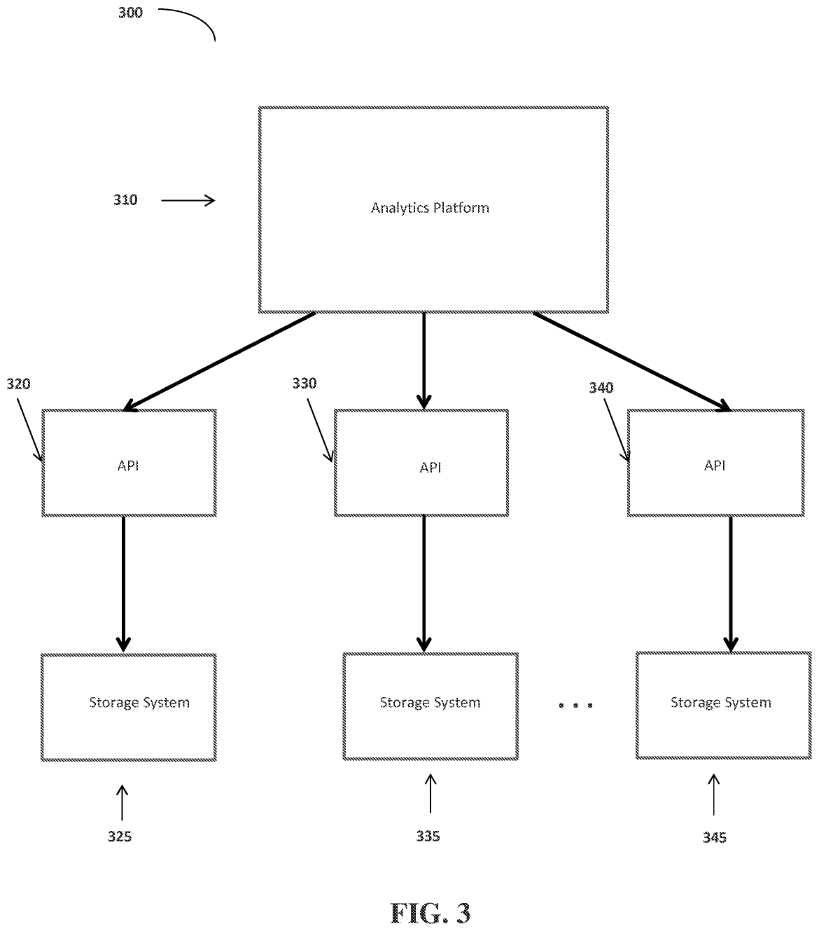

Refer now to the example embodiment of FIG. 3, simplified illustration of a block diagram of an analytics platform accessing storage systems using an API. System 300 includes analytics platform 310. Analytics platform 310 is in communication with an API 320 for storage system 325. Analytics platform 310 is in communication with an API 330 for storage system 335. Analytics platform 310 is in communication with an API 340 for storage system 345.

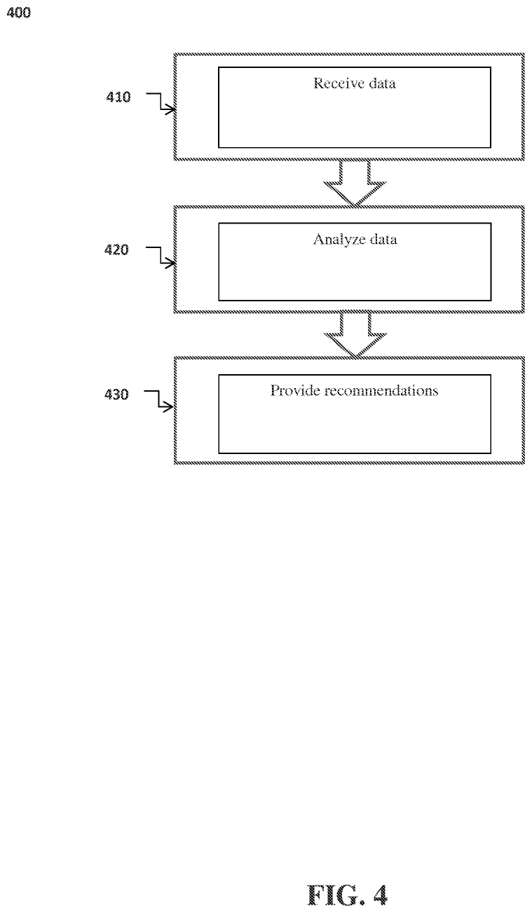

Refer now to the example embodiments of FIG. 2, FIG. 3, and FIG. 4. FIG. 4 is a simplified block diagram illustrating a method of an analytics platform receiving a high volume of information metadata to storage systems. In FIG. 2, analytics platform 210 receives storage system metadata from storage system 220, storage system 230, and storage system 240 (step 410). Analytics platform 210 analyzes the received storage system metadata (step 420). In FIG. 3, analytics platform 310 provides storage system recommendations to storage system 325, storage system 335, and storage system 345 (step 430).

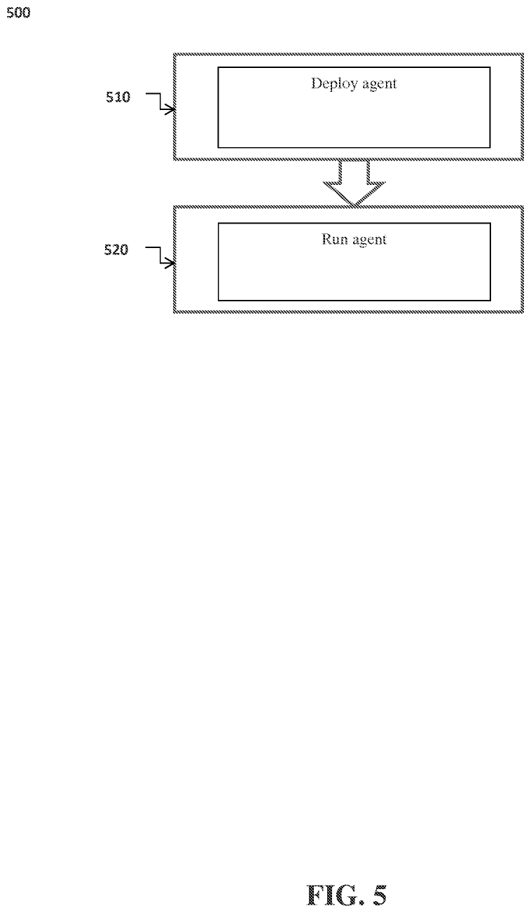

Refer now to the example embodiments of FIG. 2, and FIG. 5. FIG. 5 is a simplified block diagram illustrating a method of storage systems deploying and running software agents. In FIG. 2, storage system 225 deploys software agent 220, storage system 235 deploys software agent 230, and storage system 245 deploys software agent 240 (step 510). In FIG. 2, storage system 225 runs software agent 220, storage system 235 runs software agent 230, and storage system 245 runs software agent 240 (step 520).

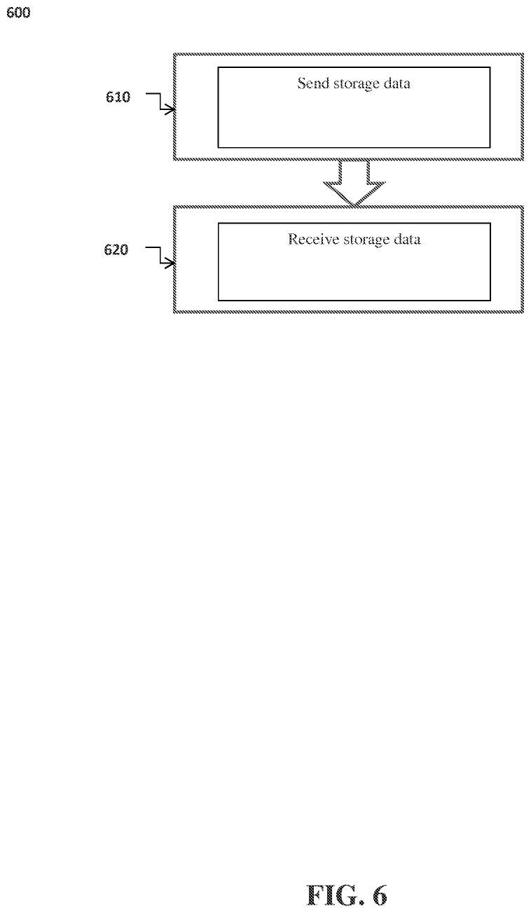

Refer now to the example embodiments of FIG. 3 and FIG. 6. FIG. 6 is a simplified block diagram illustrating a method of an analytics platform sending storage system metadata and an API receiving storage system metadata. In FIG. 3, analytics platform 310 sends storage system metadata to API 320 (Step 610). Analytics platform 310 sends storage system metadata to API 330 (step 610). Analytics platform 310 sends storage system metadata to API 340 (step 610). In FIG. 3, API 320 receives storage system metadata from analytics platform 310 (step 620). API 320 receives storage system metadata from analytics platform 310 (Step 620). API 330 receives storage system metadata from analytics platform 310 (step 620).

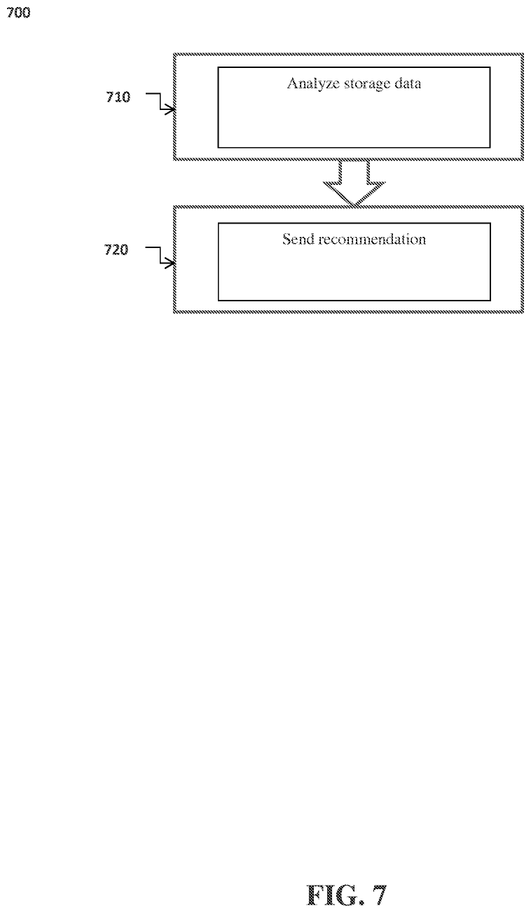

Refer now to the example embodiments of FIG. 2, FIG. 3, and FIG. 7. FIG. 7 is a simplified block diagram illustrating a method of an analytics platform analyzing storage system metadata and sending recommendations to storage systems. In FIG. 2, analytics platform 210 analyzes storage system metadata received from storage system 225, storage system 235, and storage system 245 (step 710). In FIG. 3, analytics platform 310 sends storage system recommendations to storage system 325, storage system 335, and storage system 345 (step 720).

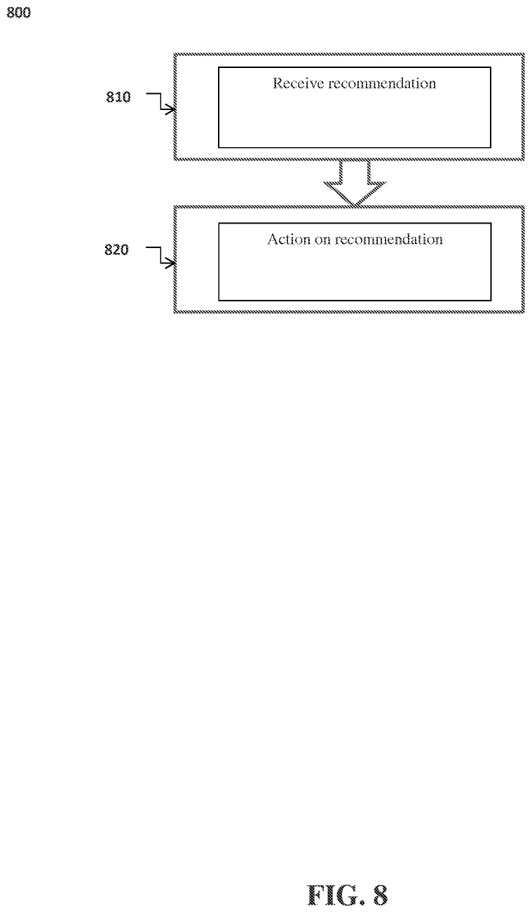

Refer now to the example embodiments of FIG. 3 and FIG. 8. FIG. 8 is a simplified block diagram illustrating a method of a storage system receiving and acting upon a storage system recommendation. In FIG. 3, storage system 325, storage system 335, and storage system 345 receive storage system recommendations from analytics platform 310 (step 810). Storage system 325, storage system 335, and storage system 345 implement storage system recommendations received from analytics platform 310 (step 820).

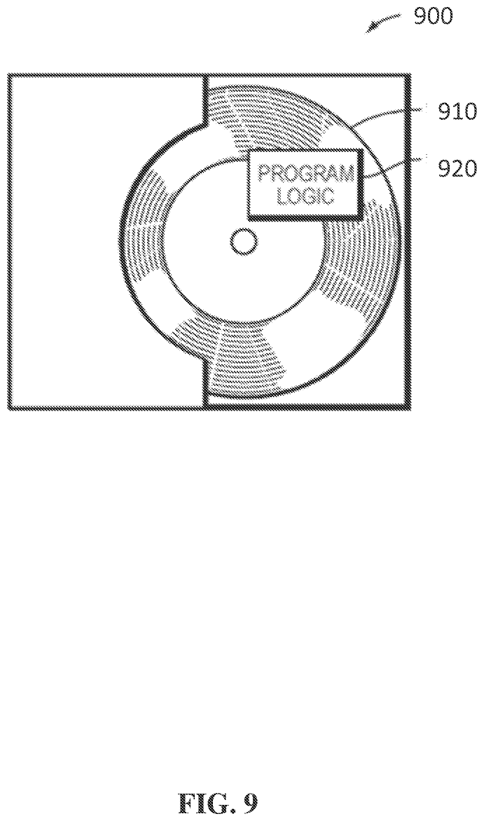

Refer now to the example embodiment of FIG. 9. FIG. 9 shows Program Logic 920 embodied on a computer-readable medium 910 as shown, and wherein the Program Logic 920 is encoded in computer-executable code configured for carrying out the measurement and analysis process of this invention and thereby forming a Computer Program Product 900.

The logic for carrying out the method may be embodied as part of the aforementioned system, which is useful for carrying out a method described with reference to embodiments shown in, for example, FIG. 4, FIG. 5, FIG. 6, FIG. 7, and FIG. 8. For purposes of illustrating the present invention, the invention is described as embodied in a specific configuration and using special logical arrangements, but one skilled in the art will appreciate that the device is not limited to the specific configuration but rather only by the claims included with this specification.

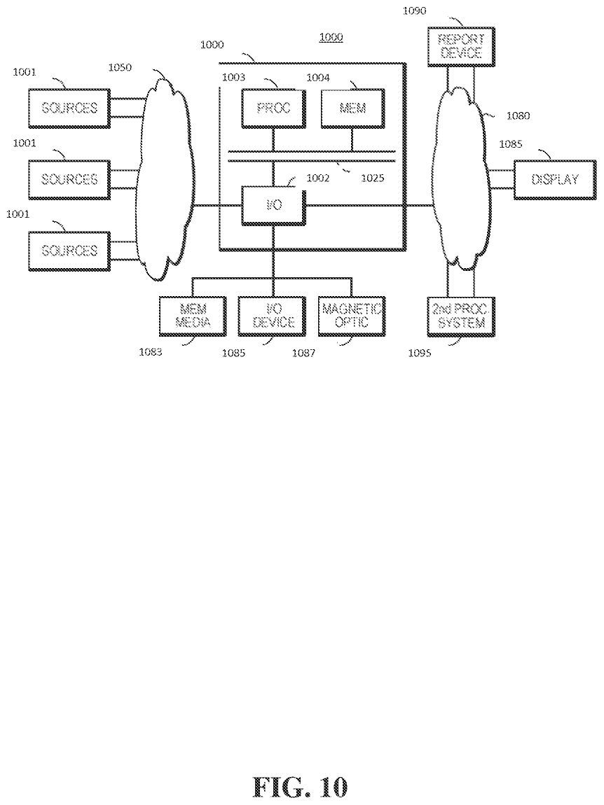

Refer now to the example embodiment of FIG. 10. The methods and apparatus of this invention may take the form, at least partially, of program code (i.e., instructions) embodied in tangible non-transitory media, such as floppy diskettes, CD-ROMs, hard drives, random access or read only-memory, or any other machine-readable storage medium. When the program code is loaded into and executed by a machine, such as the computer of FIG. 10, the machine becomes an apparatus for practicing the invention. When implemented on one or more general-purpose processors, the program code combines with such a processor to provide a unique apparatus that operates analogously to specific logic circuits. As such a general purpose digital machine can be transformed into a special purpose digital machine. A processor may be a physical processor or one or a virtual processor. In certain embodiments, a virtual processor may correspond to one or more or parts of one or more physical processors.

The scope of the invention is limited only by the claims and the invention encompasses numerous alternatives, modifications, and equivalents. Numerous specific details are set forth in the above description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured. Accordingly, the above implementations are to be considered as illustrative and not restrictive, and the invention is not to be limited to the details given herein, but may be modified within the scope and equivalents of the appended claims.

1. A method for analyzing heterogeneous storage system data, the method comprising:
receiving, by an analytics platform, metadata from a plurality of software agents, each of the software agents being executed on a different one of a plurality of heterogeneous storage systems;
analyzing the metadata,
based on the analyzed metadata, providing, by the analytics platform,
a recommendation to at least one of the heterogeneous storage systems, the recommendation being based on predictions from the analyzed metadata, the recommendation including:
hints for tiering of data, each of the hints for tiering of data identifying one of the heterogeneous storage systems and a tier within the identified storage system where data is to be placed; and
hints for increasing cache hits, each of the hints for increasing cache hits being based on an identification of one or more hotspots that are predicted to occur within a cache; and
moving data from a first one of the heterogeneous storage systems to a second one of the heterogeneous storage systems that is identified by the recommendation, the data being moved, at least in part, by the software agent that is executed on the first one of the first one of the storage system.

2. The method of claim 1, wherein any of the software agents is configured to collect information associated with a port at which an IO is received.

3. The method of claim 2, wherein any of the software agents is configured to collect information pertaining to which logical unit receives and IO, the offset of the IO, and a length of the IO.

4. The method of claim 1, wherein providing the recommendation to at least one of the heterogeneous storage systems includes providing the recommendation to the software agent that is executing on the first one of the storage systems.

5. (canceled)

6. The method of claim 3, wherein the analytics platform saves the metadata onto a software framework, and wherein the software framework stores and processes the metadata.

7. (canceled)

8. The method of claim 1, wherein providing the recommendation includes determining which data to send to which tier based on a machine learning algorithm.

9. The method of claim 1, wherein the recommendation includes a recommendation for federation of the first one of the storage systems.

10. A computer program product for analyzing heterogeneous storage system data comprising:
a non-transitory computer-readable storage medium encoded with computer-executable program code enabling:
receiving, by an analytics platform, metadata from a plurality of software agents, each of the software agents being executed on a different one of a plurality of heterogeneous storage systems;
analyzing the metadata; and
based on the analyzed metadata, providing, by the analytics platform,
a recommendation to at least one of the heterogeneous storage systems, the recommendation being based on predictions from the analyzed metadata, the recommendation including:
hints for tiering of data, each of the hints for tiering of data identifying one of the heterogeneous storage systems and a tier within the identified storage system where data is to be placed; and
hints for increasing cache hits, each of the hints for increasing cache hits being based on an identification of one or more hotspots that are predicted to occur within a cache; and
moving data from a first one of the heterogeneous storage systems to a second one of the heterogeneous storage systems that is identified by the recommendation, the data being moved, at least in part, by the software agent that is executed on the first one of the storage systems.

11. The computer program product of claim 10, wherein any of the software agents is configured to collect information associated with a port at which an IO is received.

12. The computer program product of claim 11, wherein any of the software agents is configured to collect information pertaining to which logical unit received an IO, the offset of the IO, and a length of the IO.

13. The computer program product of claim 10, wherein providing the recommendation to at least one of the heterogeneous storage systems includes providing the recommendation to the software agent that is executing on the first one of the storage systems.

14. (canceled)

15. The computer program product of claim 12, wherein the analytics platform saves the metadata onto a software framework.

16. (canceled)

17. A system for analyzing heterogeneous storage system data, the system comprising:
an analytics platform;
a plurality of heterogeneous storage systems;
a computer having a memory and a processor configured to perform the operations of:
receiving metadata from plurality of software agents, each of the software agents being executed on a different one of the plurality of heterogeneous storage systems;
analyzing the metadata;
based on the analyzed metadata, providing;
a recommendation to at least one of the heterogeneous storage systems, the recommendation being based on predictions from the analyzed metadata, the recommendation including:
hints for tiering of data, each of the hints for tiering of data identifying one of the heterogeneous storage systems and a tier within the identified storage system where data is to be placed; and
hints for increasing cache hits, each of the hints for increasing cache hits being based on an identification of one or more hotspots that are predicted to occur within a cache; and
moving data from a first one of the heterogeneous storage systems to a second of the heterogeneous storage systems that is identified by the recommendation, the data being moved, at least in part, by the software agent that is executed on the first one of the storage system.

18. (canceled)

19. The system of claim 17, wherein any of the software agents is configured to collect information associated with a port at which an IO is received.

20. The system of claim 17, wherein providing the recommendation to at least one of the heterogeneous storage systems includes providing the recommendation to the software agent that is executing on the first one of the storage systems.

21. (canceled)

22. The system of claim 19, wherein the analytics platform saves the metadata onto a software framework.

23. The method of claim 1, further comprising determining which host of a storage system to receive a flash card, wherein said determining which host of a storage system to receive a flash card includes providing for more IOs to be stored on a read cache of the host of the storage system.

24. The method according to claim 1, further including implementing a recommendation to move data from a first one of the heterogeneous storage systems to a second one of the heterogeneous storage systems based on the analyzed metadata.

25. The method according to claim 1, wherein the metadata includes information pertaining to which logical units of the heterogeneous storage systems receive IOs.

26. The method according to claim 25, wherein the IOs include an offset, a length, and a time the IOs began and ended.

27. The method according to claim 1, further including enabling, by the analytics platform, replay of IO patterns before a crash of the storage system.
